(19) United States
(12) Patent Application Publication
(10) Pub. No.: US 2026/0241681 A1
(43) Pub. Date: Aug. 20, 2026

(54) LIQUID DISCHARGE APPARATUS AND CONTROL METHOD OF LIQUID DISCHARGE APPARATUS

(71) Applicant: SEIKO EPSON CORPORATION, Tokyo (JP)

(72) Inventor: Atsuhiro HASHIMOTO, SHIOJIRI-SHI (JP)

(21) Appl. No.: 19/541,551

(22) Filed: Feb. 17, 2026

(30) Foreign Application Priority Data
Feb. 18, 2025 (JP) 2025-024028

(51) Int. Cl. B41J 2/045; B41J 2/14

(52) U.S. Cl. CPC B41J 2/04581; B41J 2/04541; B41J 2/14233

(57) ABSTRACT

A liquid discharge apparatus includes a nozzle, a pressure chamber, and a piezoelectric element that is driven by a drive signal including a first discharge element that changes from a first potential to a second potential so that the liquid from the nozzle is discharged. The piezoelectric element has a displacement characteristic in which, when a potential changes from the first potential to the second potential, a unit displacement amount, which is a displacement amount of the piezoelectric element when the applied potential changes by a unit amount, is smaller than when a potential changes from the first potential to a center potential between the first potential and the second potential. An absolute value of a change amount of a potential per 1 μs of the first discharge element is equal to or less than 0.35 times a potential difference between the first potential and the second potential.

### CROSS REFERENCE TO RELATED APPLICATION

The present application is based on, and claims priority from JP Application Serial Number 2025-024028, filed February 18, 2025, the disclosure of which is hereby incorporated by reference herein in its entirety.

### BACKGROUND

### Technical Field

The present disclosure relates to a liquid discharge apparatus and a control method of the liquid discharge apparatus.

### Related Art

A liquid discharge apparatus that prints an image by causing a plurality of nozzles to discharge a liquid such as ink by using a piezoelectric element is known. For example, a liquid discharge apparatus includes a liquid discharge head including a plurality of discharge sections. Each of the discharge sections includes a nozzle that discharges ink, a pressure chamber that communicates with the nozzle, and a piezoelectric element that applies a pressure fluctuation to the ink in the pressure chamber according to a drive signal. For example, JP-A-2012-171266 discloses a liquid ejecting apparatus in which a piezoelectric element is displaced according to an applied voltage, and a liquid is discharged from a nozzle by the displacement of the piezoelectric element.

The voltage supplied to the piezoelectric element is set to a voltage for discharging a desired amount of liquid from the nozzle. Depending on the set voltage, when the voltage supplied to the piezoelectric element fluctuates due to the influence of a circuit or the like, a discharge characteristic, such as the discharge amount or the discharge rate of the liquid, changes, so that the printing quality may deteriorate. Therefore, in the liquid discharge apparatus, it is desired to suppress a change in the discharge characteristic of the liquid when the voltage supplied to the piezoelectric element fluctuates.

### SUMMARY

According to an aspect of the present disclosure, there is provided a liquid discharge apparatus including: a liquid discharge head that includes a plurality of discharge sections each of which includes a nozzle that discharges a liquid, a pressure chamber that communicates with the nozzle, and a piezoelectric element that applies a pressure fluctuation to a liquid in the pressure chamber according to a drive signal; and a drive signal generation section that generates the drive signal, in which the drive signal includes a first discharge pulse, the first discharge pulse includes a first discharge element that drives the piezoelectric element so that a potential changes from a first potential to a second potential and a volume of the pressure chamber is contracted to discharge the liquid from the nozzle, the piezoelectric element has a displacement characteristic in which, when a potential that changes from the first potential to the second potential is applied, a unit displacement amount, which is a displacement amount of the piezoelectric element when the applied potential changes by a unit amount, is smaller than when a potential that changes from the first potential to a center potential between the first potential and the second potential is applied, and an absolute value of a change amount of a potential per 1 μs of the first discharge element is equal to or less than 0.35 times a first potential difference which is an absolute value of a potential difference between the first potential and the second potential.

In addition, according to another aspect of the present disclosure, there is provided a liquid discharge apparatus including: a liquid discharge head that includes a plurality of discharge sections each of which includes a nozzle that discharges a liquid, a pressure chamber that communicates with the nozzle, and a piezoelectric element that applies a pressure fluctuation to a liquid in the pressure chamber according to a drive signal; and a drive signal generation section that generates the drive signal, in which the drive signal includes a first discharge pulse, the first discharge pulse includes a first discharge element that drives the piezoelectric element so that a potential changes from a first potential to a second potential and a volume of the pressure chamber is contracted to discharge the liquid from the nozzle, a potential difference from the first potential to the second potential is set so that a variation in a discharge amount of the liquid when the potential difference varies is within a predetermined allowable amount, and a change amount of a potential per unit time of the first discharge element is set so that the discharge amount of liquid is a desired amount.

According to still another aspect of the present disclosure, there is provided a control method of a liquid discharge apparatus including a liquid discharge head that includes a plurality of discharge sections each of which includes a nozzle that discharges a liquid, a pressure chamber that communicates with the nozzle, and a piezoelectric element that applies a pressure fluctuation to a liquid in the pressure chamber according to a drive signal, and a drive signal generation section that generates the drive signal, in which the drive signal includes a first discharge pulse, the first discharge pulse includes a first discharge element that drives the piezoelectric element so that a potential changes from a first potential to a second potential and a volume of the pressure chamber is contracted to discharge the liquid from the nozzle, when a potential that changes from the first potential to the second potential is applied, a unit displacement amount, which is a displacement amount of the piezoelectric element when the applied potential changes by a unit amount, is smaller than when a potential that changes from the first potential to a center potential between the first potential and the second potential is applied, and an absolute value of a change amount of a potential per 1 μs of the first discharge element is equal to or less than 0.35 times a first potential difference which is an absolute value of a potential difference between the first potential and the second potential.

In addition, according to still another aspect of the present disclosure, there is provided a control method of a liquid discharge apparatus including a liquid discharge head that includes a plurality of discharge sections each of which includes a nozzle that discharges a liquid, a pressure chamber that communicates with the nozzle, and a piezoelectric element that applies a pressure fluctuation to a liquid in the pressure chamber according to a drive signal, and a drive signal generation section that generates the drive signal, in which the drive signal includes a first discharge pulse, the first discharge pulse includes a first discharge element that drives the piezoelectric element so that a potential changes from a first potential to a second potential and a volume of the pressure chamber is contracted to discharge the liquid from the nozzle, a potential difference from the first potential to the second potential is set so that a variation in a discharge amount of the liquid when the potential difference varies is within a predetermined allowable amount, and a change amount of a potential per unit time of the first discharge element is set so that the discharge amount of liquid is a desired amount.

### BRIEF DESCRIPTION OF THE DRAWINGS

FIG. 1 is a block diagram illustrating an example of a configuration of a liquid discharge apparatus according to an embodiment of the present disclosure.

FIG. 2 is a configuration diagram schematically illustrating the liquid discharge apparatus.

FIG. 3 is an explanatory diagram for describing a schematic structure of a head unit.

FIG. 4 is an explanatory diagram for describing a relationship between a drive voltage of a piezoelectric element and a discharge amount of ink.

FIG. 5 is a block diagram illustrating an example of a configuration of the head unit.

FIG. 6 is a timing chart illustrating an example of an operation of the liquid discharge apparatus in a unit period.

FIG. 7 is a timing chart illustrating an example of an operation of a liquid discharge apparatus according to a first modification example.

### DESCRIPTION OF EMBODIMENTS

Hereinafter, embodiments for carrying out the present disclosure will be described with reference to the accompanying drawings. However, in each drawing, a dimension and a scale of each section are appropriately different from actual ones. Further, since the embodiments which will be described below are suitable specific examples of the present disclosure, various technically preferable limitations are attached. However, the scope of the present disclosure is not limited to the embodiments unless the following description particularly limits the present disclosure.

### Embodiment

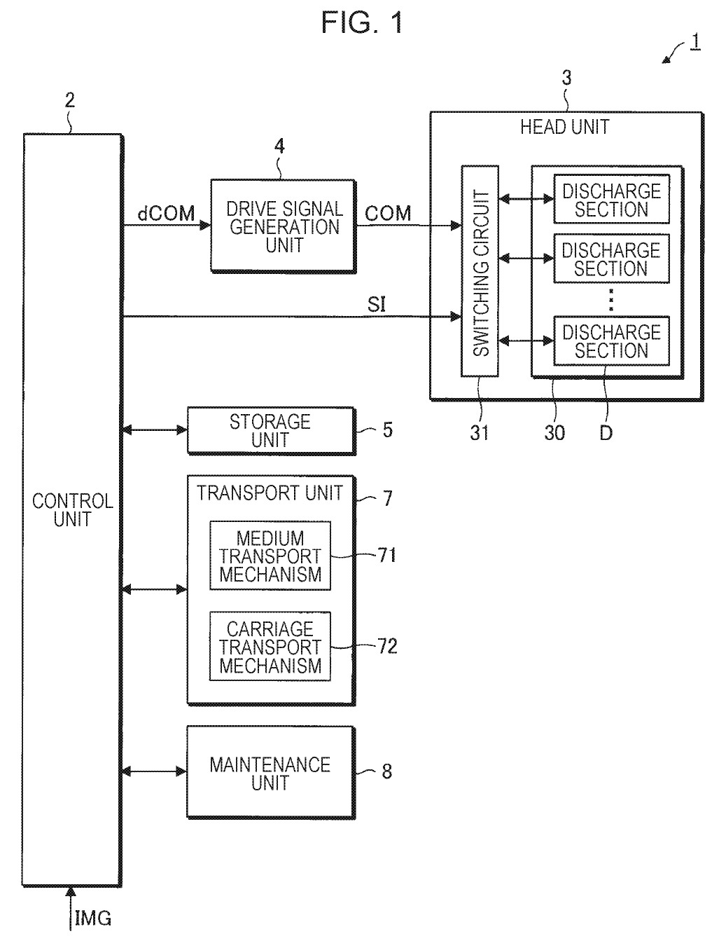

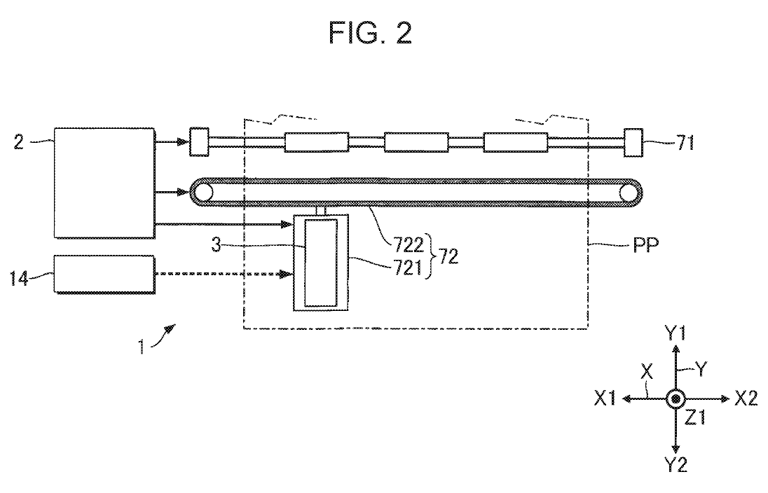

First, a configuration of a liquid discharge apparatus 1 according to the present embodiment will be described with reference to FIG. 1. In the present embodiment, a case where the liquid discharge apparatus 1 is an ink jet printer that discharges an ink to a medium to form an image is assumed as an example. In the present embodiment, the ink is an example of a "liquid". In the present embodiment, a recording paper sheet PP illustrated in FIG. 2 to be described below is assumed as the medium.

FIG. 1 is a block diagram illustrating an example of a configuration of the liquid discharge apparatus 1 according to the embodiment of the present disclosure.

For example, print data IMG indicating an image to be formed by the liquid discharge apparatus 1 is supplied to the liquid discharge apparatus 1 from a host computer such as a personal computer and a digital camera. The liquid discharge apparatus 1 performs a printing process of forming the image indicated by the print data IMG supplied from the host computer on the medium.

The liquid discharge apparatus 1 includes a control unit 2 that controls each section of the liquid discharge apparatus 1, a head unit 3 that is provided with a discharge section D that discharges ink, and a drive signal generation unit 4 that generates a plurality of drive signals COM for driving the discharge section D. Further, the liquid discharge apparatus 1 includes a storage unit 5 that stores various information such as print data IMG and a control program of the liquid discharge apparatus 1. Further, the liquid discharge apparatus 1 includes a transport unit 7 for changing a relative position of the recording paper sheet PP with respect to the head unit 3, and a maintenance unit 8 that executes a maintenance process for maintaining the discharge section D provided in the head unit 3. The head unit 3 is an example of a "liquid discharge head", and the drive signal generation unit 4 is an example of a "drive signal generation section".

In the present embodiment, it is assumed that the head unit 3 and the drive signal generation unit 4 correspond to each other. For example, the liquid discharge apparatus 1 may include the plurality of head units 3 and the plurality of drive signal generation units 4 that correspond to the plurality of head units 3 on a one-to-one basis. Alternatively, the liquid discharge apparatus 1 may include one head unit 3 and one drive signal generation unit 4 corresponding to the one head unit 3.

In the present embodiment, it is assumed that the liquid discharge apparatus 1 includes four head units 3 and four drive signal generation units 4 that correspond to the four head units 3 on a one-to-one basis. However, hereinafter, for convenience of description, as illustrated in FIG. 1, there is a case where a description will be given by focusing on one head unit 3 among the four head units 3 and one drive signal generation unit 4 provided corresponding to one head unit 3 among the four drive signal generation units 4.

The control unit 2 is configured with one or a plurality of central processing units (CPU). The control unit 2 may be configured with a programmable logic device such as a field-programmable gate array (FPGA), instead of the CPU or in addition to the CPU. Further, the control unit 2 generates a signal for controlling an operation of each section of the liquid discharge apparatus 1, such as a print signal SI and a waveform designation signal dCOM, by operating according to a control program stored in the storage unit 5.

Here, the waveform designation signal dCOM is a digital signal that defines a waveform of the drive signal COM. In addition, the drive signal COM is an analog signal used to drive the discharge section D. The print signal SI is a digital signal for designating a type of operation of the discharge section D. Specifically, the print signal SI is a signal for designating the type of operation of the discharge section D by designating whether or not to supply each drive signal COM to the discharge section D.

The drive signal generation unit 4 includes, for example, a digital analog converter (DAC), and generates the plurality of drive signals COM based on the waveform designation signal dCOM supplied from the control unit 2. For example, each of the plurality of drive signals COM generated by the drive signal generation unit 4 includes a waveform defined by the waveform designation signal dCOM. The drive signal generation unit 4 outputs the plurality of drive signals COM generated based on the waveform designation signal dCOM to a switching circuit 31 included in the head unit 3.

The storage unit 5 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 5 may be included in the control unit 2.

The head unit 3 includes a recording head 30 and a switching circuit 31.

The recording head 30 includes M discharge sections D. A value of M is a natural number that is equal to or greater than 1. Hereinafter, among the M discharge sections D provided in the recording head 30, an m-th discharge section D may be referred to as a discharge section D[m]. In this case, the variable m is a natural number that satisfies "1 ≤ m ≤ M". In addition, hereinafter, when a component, a signal, or the like of the liquid discharge apparatus 1 corresponds to the discharge section D[m] among the M discharge sections D, a suffix [m] may be added to reference numerals for representing the component, the signal, or the like.

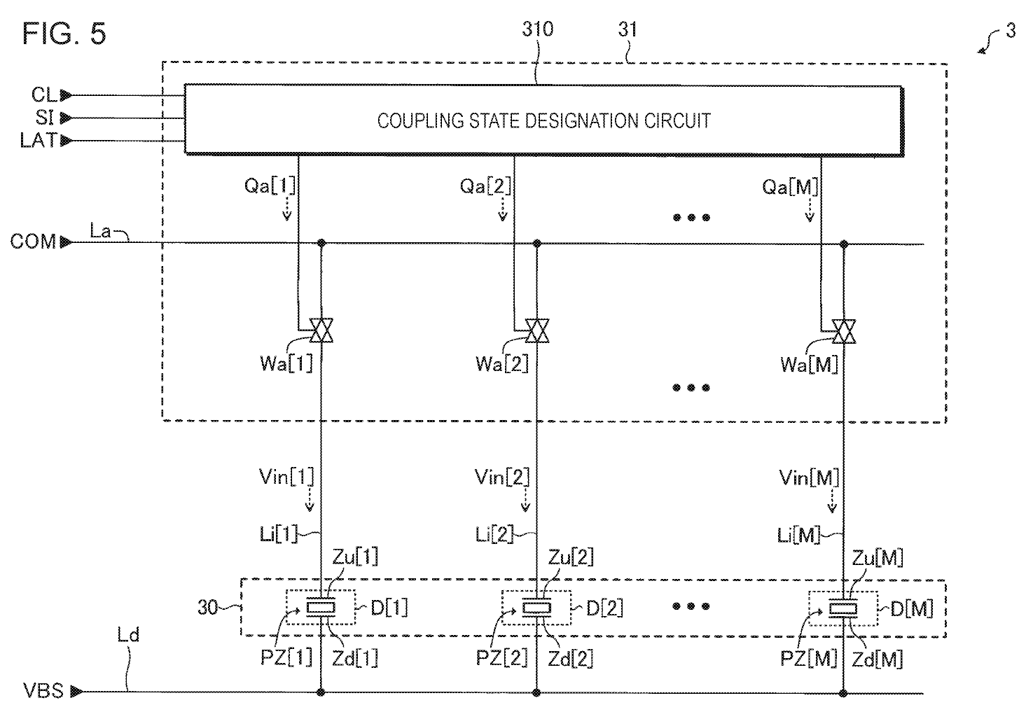

The switching circuit 31 switches whether or not to supply each drive signal COM to the discharge section D[m], based on the print signal SI. Hereinafter, the drive signal COM supplied to the discharge section D[m] may be referred to as an individual drive signal Vin[m], as illustrated in FIG. 5 and the like to be described below.

As described above, in the present embodiment, the liquid discharge apparatus 1 executes the printing process. When the printing process is executed, the control unit 2 generates a signal for controlling the head unit 3 such as the print signal SI based on the print data IMG. In addition, the control unit 2 generates a signal for controlling the drive signal generation unit 4, such as the waveform designation signal dCOM, when the printing process is executed. In addition, the control unit 2 generates a signal for controlling the transport unit 7 when the printing process is executed. Therefore, in the printing process, the control unit 2 adjusts the presence or absence of discharge of inks from the discharge section D[m], the discharge amount of inks, a discharge timing of the inks, and the like while controlling the transport unit 7 to change a relative position of the recording paper sheet PP with respect to the head unit 3. As described above, the control unit 2 controls each section of the liquid discharge apparatus 1 so that an image corresponding to the print data IMG is formed at the recording paper sheet PP.

The transport unit 7 includes a carriage transport mechanism 72 for reciprocating a carriage 721 and a medium transport mechanism 71 for transporting the recording paper sheet PP. The carriage 721 will be described below in FIG. 2.

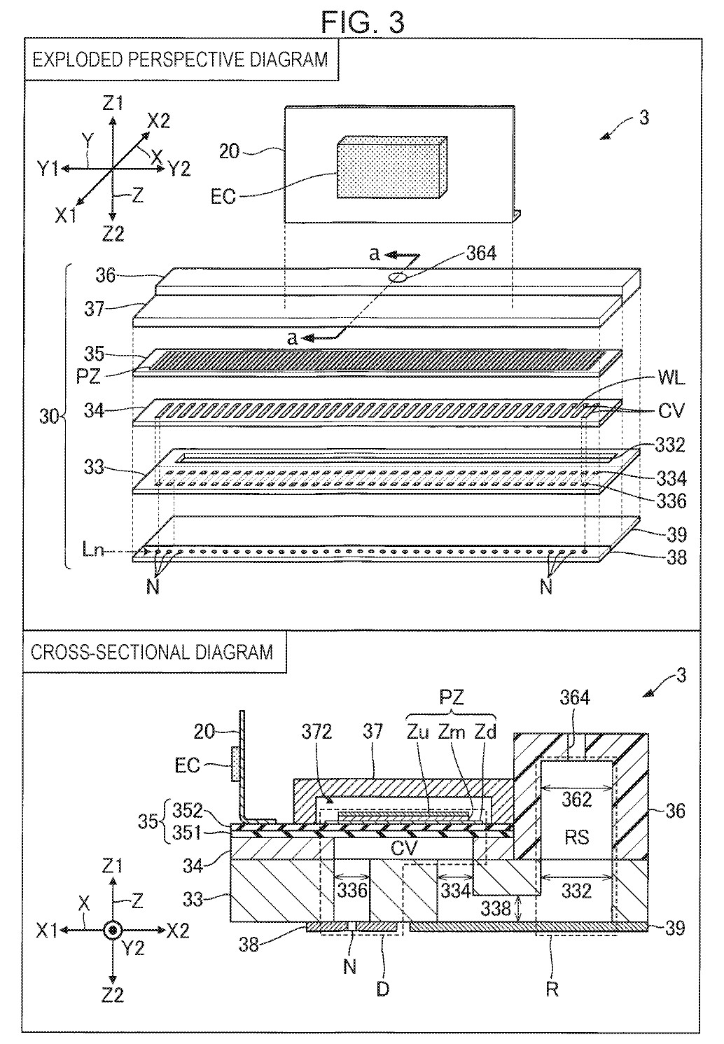

Further, as described above, in the present embodiment, the liquid discharge apparatus 1 executes the maintenance process. For example, the maintenance process includes flushing processing of discharging inks from the discharge section D, wiping processing of wiping off a foreign matter such as an ink adhering to the vicinity of a nozzle N of the discharge section D with a wiper, and pumping processing of suctioning the ink in the discharge section D with a tube pump or the like. The nozzle N will be described below in FIG. 3.

The maintenance unit 8 includes a discharged ink receiving section for receiving the discharged ink when the ink in the discharge section D is discharged, a wiper for wiping off a foreign matter such as an ink adhering to the vicinity of the nozzle N of the discharge section D, and a tube pump for suctioning the ink, air bubbles, and the like in the discharge section D, in the flushing processing. The discharged ink receiving section, the wiper, and the tube pump are not illustrated.

Next, a schematic overall configuration of the liquid discharge apparatus 1 will be described with reference to FIG. 2.

FIG. 2 is a configuration diagram schematically illustrating the liquid discharge apparatus 1. As illustrated in FIG. 2, in the present embodiment, it is assumed that the liquid discharge apparatus 1 is a serial printer as an example.

As illustrated in FIG. 2, the liquid discharge apparatus 1 includes a liquid container 14 that stores ink, in addition to the elements described in FIG. 1. As the liquid container 14, for example, a cartridge that can be attached to and detached from the liquid discharge apparatus 1, a bag-shaped ink pack formed of a flexible film, an ink tank that can be replenished with ink, or the like can be employed. A type of ink to be stored in the liquid container 14 is not particularly limited and is selected in any desired way.

The medium transport mechanism 71 transports the recording paper sheet PP in a Y2 direction along a Y axis under the control of the control unit 2. Hereinafter, a Y1 direction and the Y2 direction opposite to the Y1 direction are collectively referred to as a direction along the Y axis. In addition, hereinafter, an X1 direction along an X axis that intersects the Y axis and an X2 direction opposite to the X1 direction are collectively referred to as a direction along the X axis. In addition, hereinafter, a Z1 direction along a Z axis that intersects the X axis and the Y axis and a Z2 direction opposite to the Z1 direction are collectively referred to as a direction along the Z axis. In the present embodiment, as an example, description will be performed while assuming that the X axis, the Y axis, and the Z axis are orthogonal to each other. However, the present disclosure is not limited to such an aspect. The X axis, the Y axis, and the Z axis may intersect each other. In the present embodiment, the Z2 direction corresponds to an ink discharge direction from the discharge section D[m].

The carriage transport mechanism 72 reciprocates the head unit 3 in the X1 direction and the X2 direction under the control of the control unit 2. As illustrated in FIG. 2, the carriage transport mechanism 72 includes the substantially box-shaped carriage 721 accommodating the head unit 3 and an endless belt 722 to which the carriage 721 is fixed. The liquid container 14 may be stored in the carriage 721 together with the head unit 3.

Next, a schematic structure of the head unit 3 will be described with reference to FIG. 3.

FIG. 3 is an explanatory diagram for describing the schematic structure of the head unit 3. The upper part of FIG. 3 is an exploded perspective diagram of the head unit 3, and the lower part of FIG. 3 is a cross-sectional diagram taken along the line a-a illustrated in the exploded perspective diagram. The a-a cross section is parallel to the XZ plane and passes through an introduction port 364 described below.

As illustrated in FIG. 3, the head unit 3 includes a wiring substrate 20 on which an electronic component EC is mounted, a flow path substrate 33, a pressure chamber substrate 34, a vibration plate 35, and M piezoelectric elements PZ, a case 36, a sealing plate 37, a nozzle substrate 38, and a vibration absorber 39. The electronic component EC includes, for example, an electric circuit such as the switching circuit 31. For example, the recording head 30 is electrically coupled to the switching circuit 31 or the like via the wiring substrate 20. As illustrated in the exploded perspective diagram of FIG. 3, the recording head 30 includes, for example, a flow path substrate 33, a pressure chamber substrate 34, a vibration plate 35, M piezoelectric elements PZ, a case 36, a sealing plate 37, a nozzle substrate 38, and a vibration absorber 39.

Here, the pressure chamber substrate 34, the vibration plate 35, the M piezoelectric elements PZ, the case 36, and the sealing plate 37 are installed in a region located in the Z1 direction from the flow path substrate 33. On the other hand, the nozzle substrate 38 and the vibration absorber 39 are installed in a region located in the Z2 direction from the flow path substrate 33. In addition, the wiring substrate 20 is provided on a surface of the vibration plate 35 in the Z1 direction, for example. Each element of the head unit 3 is generally a plate-shaped member elongated in the direction along the Y axis, and is joined to each other with an adhesive, for example.

As illustrated in the exploded perspective diagram of FIG. 3, the nozzle substrate 38 is a plate-shaped member in which a nozzle row Ln including M nozzles N arranged along the Y axis is formed. Each of the nozzles N is a through-hole through which ink passes. The flow path substrate 33, the pressure chamber substrate 34, and the nozzle substrate 38 are formed by processing, for example, a silicon single crystal substrate by a semiconductor manufacturing technology such as etching. Meanwhile, a material or a manufacturing method of each element of the head unit 3 is optional. The direction of the Y axis can also be referred to as a direction in which the M nozzles N are arranged.

The flow path substrate 33 is a plate-shaped member for forming a flow path for inks. As illustrated in FIG. 3, the flow path substrate 33 is formed with an opening portion 332, M supply flow paths 334, and M communication flow paths 336. The opening section 332 is a through-hole that is continuous over the M nozzles N along the Y axis in a plan view from the direction along the Z axis. That is, the opening section 332 is a long through-hole extending in the direction along the Y axis. The supply flow path 334 and the communication flow path 336 are through holes individually formed for each of the nozzles N. As illustrated in the cross-sectional diagram in FIG. 3, a relay flow path 338 over the M supply flow paths 334 is formed at a surface of the flow path substrate 33 in the Z2 direction. The relay flow path 338 is a flow path that allows the opening section 332 and the M supply flow paths 334 to communicate with each other.

The pressure chamber substrate 34 is a plate-shaped member in which M pressure chambers CV respectively corresponding to the M nozzles N are formed. The pressure chamber CV is located between the flow path substrate 33 and the vibration plate 35, and is a space called a cavity for applying pressure to an ink filled in the pressure chamber CV. The M pressure chambers CV are partitioned by the partition wall WL of the pressure chamber substrate 34 and are arranged in the direction along the Y axis. Each pressure chamber CV is configured with a hole that opens at both surfaces of the pressure chamber substrate 34, and has a long shape extending in the direction along the X axis. An end of each pressure chamber CV in the X2 direction communicates with the corresponding supply flow path 334 among the M supply flow paths 334. On the other hand, an end of each pressure chamber CV in the X1 direction communicates with the corresponding communication flow path 336 among the M communication flow paths 336.

The vibration plate 35 is installed on a surface of the pressure chamber substrate 34 in a direction opposite to a surface of the pressure chamber substrate 34, facing the flow path substrate 33. The vibration plate 35 is a plate-shaped member that is elastically deformable. As illustrated in the cross-sectional diagram of FIG. 3, the vibration plate 35 includes an insulating film 352 and an elastic film 351 laminated in the direction along the Z axis. The insulating film 352 is located in a direction opposite to the pressure chamber substrate 34 when viewed from the elastic film 351. The elastic film 351 is formed of, for example, silicon oxide. The insulating film 352 is formed of, for example, zirconium oxide.

As can be understood from FIG. 3, the flow path substrate 33 and the vibration plate 35 face each other at an interval inside each of the pressure chambers CV. The vibration plate 35 forms a part of a wall surface of the pressure chamber CV. An ink stored in a liquid storage chamber RS which will be described later branches from the relay flow path 338 to each supply flow path 334 and is supplied to and filled into the M pressure chambers CV in parallel.

As illustrated in FIG. 3, the M piezoelectric elements PZ respectively corresponding to the M nozzles N are installed on a surface of the vibration plate 35 in a direction opposite to the pressure chamber substrate 34. For example, for any m from 1 to M, the nozzle N[m] corresponds to the piezoelectric element PZ[m]. The nozzle N corresponding to the piezoelectric element PZ is the nozzle N communicating with the pressure chamber CV that partially or entirely overlaps with the piezoelectric element PZ in a plan view in the Z2 direction. Each of the piezoelectric elements PZ is an actuator that is deformed by the supply of the drive signal COM and is formed in a long shape in a direction along the X axis. The M piezoelectric elements PZ are arranged in the direction along the Y axis to correspond to the M pressure chambers CV. When the drive signal COM is supplied to the piezoelectric element PZ and the vibration plate 35 vibrates in conjunction with deformation of the piezoelectric element PZ, pressure in the pressure chamber CV fluctuates. As the pressure in the pressure chamber CV fluctuates, the ink filled in the pressure chamber CV passes through the communication flow path 336 and the nozzle N and is discharged. That is, the piezoelectric element PZ is a drive element that discharges the ink in the pressure chamber CV from the nozzle N by vibrating the vibration plate 35.

As illustrated in the cross-sectional diagram of FIG. 3, the piezoelectric element PZ has an upper electrode Zu, a lower electrode Zd, and a piezoelectric body Zm provided between the upper electrode Zu and the lower electrode Zd. For example, the drive signal COM is supplied to the upper electrode Zu, and a bias voltage signal VBS having a constant potential illustrated in FIG. 5 which will be described later is supplied to the lower electrode Zd. Further, the pressure chamber CV is provided in the Z2 direction of a piezoelectric element PZ.

In the cross-sectional diagram of FIG. 3, in order to avoid the drawing from being complicated, a wiring which is coupled to the upper electrode Zu and supplies the drive signal COM to the upper electrode Zu, and a wiring which is coupled to the lower electrode Zd and supplies the bias voltage signal VBS to the lower electrode Zd are not illustrated. In the present embodiment, a case is assumed in which the drive signal COM is supplied to the upper electrode Zu and the bias voltage signal VBS is supplied to the lower electrode Zd. Meanwhile, the bias voltage signal VBS may be supplied to the upper electrode Zu and the drive signal COM may be supplied to the lower electrode Zd.

Here, in the present embodiment, as an example, it is assumed that the piezoelectric element PZ is displaced in the Z2 direction by changing a potential of the individual drive signal Vin[m] supplied to the discharge section D[m] from a low potential to a high potential. That is, in the present embodiment, it is assumed that the volume of the pressure chamber CV provided in the discharge section D[m] is decreased when the potential of the individual drive signal Vin[m] supplied to the discharge section D[m] is high, in comparison with a case where the potential is low.

As illustrated in FIG. 3, the case 36 is, for example, a structure manufactured by injection molding of a resin material and is fixed to a surface of the flow path substrate 33 in the Z1 direction. As illustrated in the cross-sectional diagram of FIG. 3, the case 36 is formed with an accommodation section 362 and an introduction port 364. The accommodation section 362 is a recess section having a shape corresponding to the opening section 332 of the flow path substrate 33. The introduction port 364 is a through-hole that communicates with the accommodation section 362. A space of the opening section 332 of the flow path substrate 33 and the accommodation section 362 of the case 36 functions as the liquid storage chamber RS which is a reservoir which stores inks to be supplied to the M pressure chambers CV. The ink supplied from the liquid container 14 and passing through the introduction port 364 is stored in the liquid storage chamber RS.

The sealing plate 37 has a structure that protects the M piezoelectric elements PZ from the outside air and reinforces the mechanical strength of the pressure chamber substrate 34 and the vibration plate 35. The sealing plate 37 is fixed to a surface of the vibration plate 35 with, for example, an adhesive. As illustrated in the cross-sectional diagram of FIG. 3, the sealing plate 37 has a recess section on a surface facing the vibration plate 35. A sealing space 372 is formed by fixing the sealing plate 37 to the surface of the vibration plate 35. The M piezoelectric elements PZ are provided in the sealing space 372.

The vibration absorber 39 absorbs the pressure fluctuation in the liquid storage chamber RS. That is, the vibration absorber 39 absorbs the vibration of the inks stored in the liquid storage chamber RS. For example, the vibration absorber 39 includes a flexible sheet member that can be elastically deformed. Specifically, the vibration absorber 39 is installed on a surface of the flow path substrate 33 in the Z2 direction so that a bottom surface of the liquid storage chamber RS is formed by closing the opening section 332 of the flow path substrate 33, the relay flow path 338, and the plurality of supply flow paths 334.

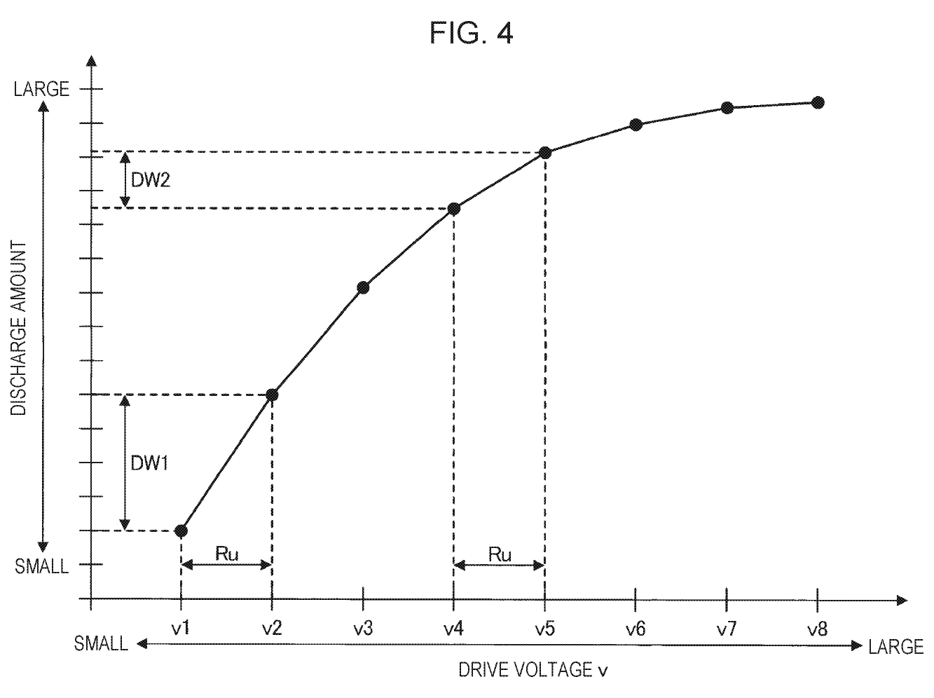

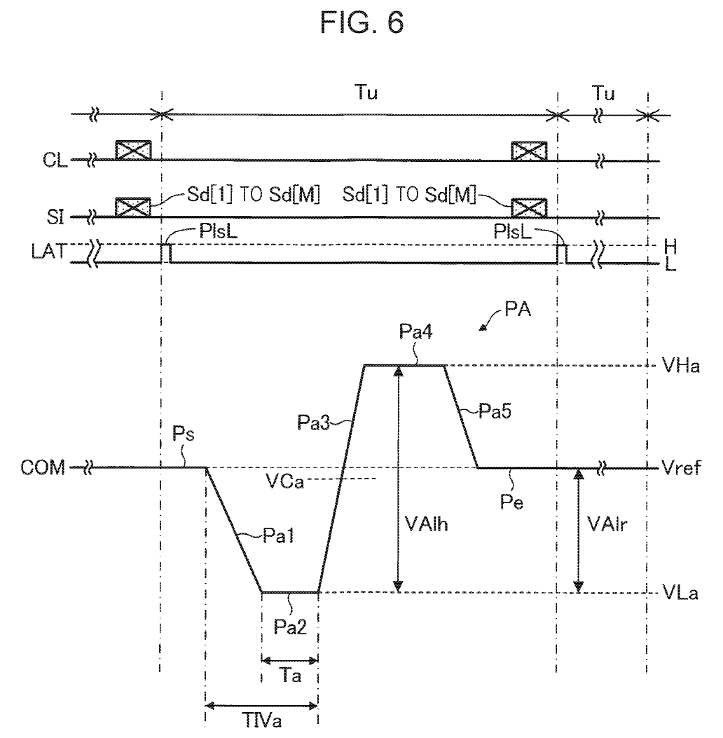

Next, an example of the relationship between the drive voltage v of the piezoelectric element PZ and the discharge amount of ink will be described with reference to FIG. 4. In the present embodiment, as the drive voltage v of the piezoelectric element PZ, for example, the potential difference VAlh between the potential VLa at the start point and the potential VHa at the end point of the waveform element Pa3 illustrated in FIG. 6 which will be described later is used. The waveform element Pa3 is an element of the drive signal COM and is a discharge element that discharges ink from the nozzle N.

FIG. 4 is an explanatory diagram for describing a relationship between the drive voltage v of the piezoelectric element PZ and the discharge amount of ink. The horizontal axis of FIG. 4 indicates the drive voltage v of the piezoelectric element PZ, and the vertical axis indicates the discharge amount of ink.

As illustrated in FIG. 4, the discharge amount of ink increases as the drive voltage v of the piezoelectric element PZ increases. However, when the drive voltage v of the piezoelectric element PZ is high, the unit change amount, which is a change in the discharge amount of ink when the drive voltage v of the piezoelectric element PZ changes by a unit amount, is small as compared with the case where the drive voltage v of the piezoelectric element PZ is low. In FIG. 4, in order to facilitate the description, it is assumed that the unit change amount of the discharge amount of ink is the change amount of the discharge amount of ink when the drive voltage v of the piezoelectric element PZ changes by a predetermined amount Ru. For example, the unit change amount of the discharge amount of ink when the drive voltage v of the piezoelectric element PZ changes from the voltage v1 to the voltage v2 which is higher than the voltage v1 by a predetermined amount Ru is the change amount DW1. For example, the unit change amount of the discharge amount of ink when the drive voltage v of the piezoelectric element PZ changes from the voltage v4 which is higher than the voltage v1 to the voltage v5 which is higher than the voltage v4 by the predetermined amount Ru is a change amount DW2 which is smaller than the change amount DW1.

As described above, when the drive voltage v of the piezoelectric element PZ changes within the range from the voltage v4 to the voltage v5, the sensitivity of the change in the discharge amount of ink with respect to the change in the drive voltage v of the piezoelectric element PZ is low as compared with the case where the drive voltage v of the piezoelectric element PZ changes within the range from the voltage v1 to the voltage v2. That is, as understood from FIG. 4, when the drive voltage v of the piezoelectric element PZ is high, the sensitivity of the change in the discharge amount of ink with respect to the change in the drive voltage v of the piezoelectric element PZ is low as compared with the case where the drive voltage v of the piezoelectric element PZ is low.

Therefore, in the present embodiment, the drive voltage v of the piezoelectric element PZ is set in a range in which the sensitivity of the change in the discharge amount of ink with respect to the change in the drive voltage v is low. For example, the drive voltage v of the piezoelectric element PZ is set so that the variation in the discharge amount of ink when the drive voltage v varies within the assumed range is within a predetermined allowable range. Specifically, for example, when the variation in the discharge amount of ink is set to ± 10% or less with respect to the desired discharge amount, it is preferable to set the drive voltage v of the piezoelectric element PZ so that the variation in the discharge amount when the drive voltage v varies within the assumed range is within a range of approximately ± 4% with respect to the desired discharge amount. It is preferable that the potential change rate of the waveform element Pa3, which is the discharge element that discharges the ink from the nozzle N, is set so that the discharge amount of the ink is the desired discharge amount in the drive voltage v set so that the variation in the discharge rate of the ink is within the predetermined allowable range. The potential change rate is the change amount of potential per unit time. As described above, in the present embodiment, the drive voltage v of the piezoelectric element PZ is set in a range in which the sensitivity of the change in the discharge amount of ink with respect to the change in the drive voltage v is low. Therefore, it is possible to suppress the change in the discharge amount of ink when the drive voltage v of the piezoelectric element PZ fluctuates.

The relationship between the drive voltage v of the piezoelectric element PZ and the discharge rate of the ink is the same as the relationship between the drive voltage v of the piezoelectric element PZ and the discharge amount of ink. For example, the discharge rate of the ink increases as the drive voltage v of the piezoelectric element PZ increases. In addition, when the drive voltage v of the piezoelectric element PZ is high, the unit change amount, which is the change amount of the discharge rate of the ink when the drive voltage v of the piezoelectric element PZ changes by the unit amount, is small as compared with the case where the drive voltage v of the piezoelectric element PZ is low. That is, when the drive voltage v of the piezoelectric element PZ is high, the sensitivity of the change in the discharge rate of the ink with respect to the change in the drive voltage v of the piezoelectric element PZ is low as compared with the case where the drive voltage v of the piezoelectric element PZ is low. Therefore, when the drive voltage v of the piezoelectric element PZ is set to suppress the change in the discharge amount of ink when the drive voltage v of the piezoelectric element PZ changes, the change in the discharge rate of the ink when the drive voltage v of the piezoelectric element PZ changes can also be suppressed. That is, in the present embodiment, it is possible to suppress the change in the discharge characteristics, such as the discharge amount and the discharge rate of the ink, when the drive voltage v of the piezoelectric element PZ changes.

Here, the discharge amount of ink changes substantially linearly according to the displacement amount of the piezoelectric element PZ. Therefore, the relationship between the drive voltage v of the piezoelectric element PZ and the displacement amount of the piezoelectric element PZ is also the same as the relationship between the drive voltage v of the piezoelectric element PZ and the discharge amount of ink. For example, the displacement amount of the piezoelectric element PZ increases as the drive voltage v of the piezoelectric element PZ increases. In addition, when the drive voltage v of the piezoelectric element PZ is high, the unit displacement amount, which is the displacement amount of the piezoelectric element PZ when the drive voltage v of the piezoelectric element PZ changes by the unit amount, is small as compared with the case where the drive voltage v of the piezoelectric element PZ is low. That is, when the drive voltage v of the piezoelectric element PZ is high, the sensitivity of the displacement of the piezoelectric element PZ with respect to the change in the drive voltage v of the piezoelectric element PZ is low as compared with the case where the drive voltage v of the piezoelectric element PZ is low. As described above, when the drive voltage v of the piezoelectric element PZ is high, the piezoelectric element PZ has a displacement characteristic in which the unit displacement amount is small as compared with the case where the drive voltage v of the piezoelectric element PZ is small.

Next, an outline of the head unit 3 will be described with reference to FIG. 5.

FIG. 5 is a block diagram illustrating an example of the configuration of the head unit 3.

As described in FIG. 1, the head unit 3 includes a recording head 30 and a switching circuit 31. In addition, the head unit 3 has a wiring La to which the drive signal COM is supplied from the drive signal generation unit 4, a wiring Li[m] for supplying an individual drive signal Vin[m] to the discharge section D[m], and a wiring Ld to which the bias voltage signal VBS is supplied.

The switching circuit 31 includes M switches Wa[1] to Wa[M] corresponding to the M discharge sections D[1] to D[M] in a one-to-one relationship, and a coupling state designation circuit 310. The coupling state designation circuit 310 designates the coupling state of each of the M switches Wa. For example, the coupling state designation circuit 310 generates a coupling state designation signal Qa[m] that designates the on/off of the switch Wa[m] based on at least a part of the print signal SI and the latch signal LAT supplied from the control unit 2.

The switch Wa[m] switches conduction and non-conduction between the wiring La and the upper electrode Zu[m] of the piezoelectric element PZ[m] provided in the discharge section D[m], based on the coupling state designation signal Qa[m]. That is, the switch Wa[m] switches conduction and non-conduction between the wiring La and the wiring Li[m] coupled to the upper electrode Zu[m], based on the coupling state designation signal Qa[m]. In the present embodiment, the switch Wa[m] is turned on when the coupling state designation signal Qa[m] is at a high level and is turned off when the coupling state designation signal Qa[m] is at a low level. When the switch Wa[m] is turned on, the drive signal COM supplied to the wiring La is supplied to the upper electrode Zu[m] of the discharge section D[m] as the individual drive signal Vin[m] via the wiring Li[m].

Next, an operation of the liquid discharge apparatus 1 in a unit period Tu will be described with reference to FIG. 6.

FIG. 6 is a timing chart illustrating an example of the operation of the liquid discharge apparatus 1 in the unit period Tu. In the present embodiment, when the liquid discharge apparatus 1 performs the printing process, a printing process period including one or a plurality of unit periods Tu is set as an operation period of the liquid discharge apparatus 1. The liquid discharge apparatus 1 according to the present embodiment can drive each discharge section D for the printing process in each unit period Tu. The unit period Tu is, for example, a drive cycle of the M discharge sections D. In the present embodiment, it is assumed that one cycle of the drive signal COM is the unit period Tu.

The control unit 2 outputs the latch signal LAT having a pulse PlsL. Therefore, the control unit 2 defines the unit period Tu as a period from rising of the pulse PlsL to rising of the next pulse PlsL.

The print signal SI includes, for example, M individual designation signals Sd[1] to Sd[M] corresponding to the M discharge sections D[1] to D[M] on a one-to-one basis. The individual designation signal Sd[m] designates an aspect of driving of the discharge section D[m] in each unit period Tu when the liquid discharge apparatus 1 performs the printing process.

The control unit 2 supplies the print signal SI including the individual designation signals Sd[1] to Sd[M] to the coupling state designation circuit 310 in synchronization with the clock signal CL before each unit period Tu in which the printing process is executed. The coupling state designation circuit 310 generates a coupling state designation signal Qa[m] based on the individual designation signal Sd[m] in the unit period Tu.

For example, by the individual designation signal Sd[m], the discharge section D[m] is designated to any one of the discharge section D that forms dots and the discharge section D that does not form dots in the unit period Tu in which the printing process is executed. In the discharge section D that forms the dots, the piezoelectric element PZ of the discharge section D is driven so that the ink is discharged from the nozzle N of the discharge section D. For example, the drive signal COM illustrated in FIG. 6 is supplied as the individual drive signal Vin[m] to the discharge section D[m] that forms the dots.

The drive signal COM includes a pulse PA that discharges ink from the nozzle N, a waveform element Ps that is an element before the pulse PA, and a waveform element Pe that is an element after the pulse PA. The pulse PA is an example of a "first discharge pulse". The waveform element Ps, the pulse PA, and the waveform element Pe are supplied to the wiring La in the unit period Tu when, for example, the drive signal COM is supplied to the wiring La.

For example, the waveform element Ps is an element that maintains the potential of the drive signal COM at the reference potential Vref from the start of the unit period Tu until the start of the pulse PA. In addition, the waveform element Pe is an element that maintains the potential of the drive signal COM at the reference potential Vref from the end of the pulse PA until the end of the unit period Tu.

The pulse PA is a pulse in which the potential of the drive signal COM returns from the reference potential Vref to the reference potential Vref via the potential VLa and the potential VHa. The potential VLa is a potential lower than the reference potential Vref and is the lowest potential of the pulse PA. The potential VHa is a potential higher than the reference potential Vref and is the maximum potential of the pulse PA. That is, the reference potential Vref is a potential between the potential VLaand the potential VHa. The potential VLa is an example of a "first potential", and the potential VHa is an example of a "second potential". The reference potential Vref is an example of a "third potential". Each of the reference potential Vref, the potential VLa, and the potential VHa is determined based on, for example, the ink discharge characteristic of the discharge section D. For example, as described with reference to FIG. 4, the potential VLa and the potential VHa are determined so that the potential difference VAlh between the potential VLa and the potential VHa is in a range in which the sensitivity of the change in the discharge amount of ink with respect to the change in the potential difference VAlh is low. The potential change rate of the waveform element Pa3 included in the pulse PA is determined so that the discharge amount of ink is a desired discharge amount. In the example illustrated in FIG. 6, the pulse PA includes the waveform elements Pa1, Pa2, Pa4, and Pa5 in addition to the waveform element Pa3.

The waveform element Pa1 is an element after the waveform element Ps and is an expansion element for displacing the piezoelectric element PZ in the Z1 direction. In the expansion element, the potential of the drive signal COM changes so as to expand a volume of the pressure chamber CV. For example, in the waveform element Pa1, the potential of the drive signal COM changes from the reference potential Vref to the potential VLa to drive the piezoelectric element PZ so as to expand the volume of the pressure chamber CV. When the volume of the pressure chamber CV expands, a surface of an ink in the nozzle N is pulled in the Z1 direction, which is a direction opposite to the discharge direction. Hereinafter, the pulling of the surface of the ink in the nozzle N in the direction opposite to the discharge direction may be referred to as a pull. The waveform element Pa1 is an example of a "first expansion element".

The waveform element Pa2 is an element after the waveform element Pa1 and is a maintenance element for maintaining the position of the piezoelectric element PZ in the direction along the Z axis. For example, in the waveform element Pa2, the potential of the drive signal COM is maintained to drive the piezoelectric element PZ to maintain the volume of the pressure chamber CV expanded by the waveform element Pa1. Therefore, in the waveform element Pa2, the potential of the drive signal COM is maintained at the potential VLa, which is the potential of the end point of the waveform element Pa1. For example, the waveform element Pa2 maintains the potential of the drive signal COM at the potential VLa from the end point of the waveform element Pa1 to the start point of the waveform element Pa3. The waveform element Pa2 is an example of a "first expansion maintenance element".

The waveform element Pa3 is an element after the waveform element Pa2 and is a contraction element for displacing the piezoelectric element PZ in the Z2 direction. In the contraction element, the potential of the drive signal COM changes to contract the volume of the pressure chamber CV. For example, in the waveform element Pa3, the potential of the drive signal COM changes from the potential VLa to the potential VHa to drive the piezoelectric element PZ to contract the volume of the pressure chamber CV. When the volume of the pressure chamber CV is contracted, the surface of the ink in the nozzle N is pushed out in the Z2 direction, which is the discharge direction. As a result, the ink is discharged from the nozzle N. As described above, the waveform element Pa3 is an element in which the potential of the drive signal COM changes from the potential VLa to the potential VHa, and drives the piezoelectric element PZ to contract the volume of the pressure chamber CV and discharge the ink from the nozzle N. Hereinafter, the act of pushing the surface of the ink in the nozzle N in the discharge direction may be referred to as a push. The waveform element Pa3 is an example of a "first discharge element".

The waveform element Pa4 is a maintenance element after the waveform element Pa3. For example, in the waveform element Pa4, the potential of the drive signal COM is maintained at the potential VHa of the end point of the waveform element Pa3 to drive the piezoelectric element PZ to maintain the volume of the pressure chamber CV contracted by the waveform element Pa3. For example, the waveform element Pa4 maintains the potential of the drive signal COM at the potential VHa from the end point of the waveform element Pa3 to the start point of the waveform element Pa5. The waveform element Pa4 is an example of a "first contraction maintenance element".

The waveform element Pa5 is an expansion element after the waveform element Pa4. For example, in the waveform element Pa5, the potential of the drive signal COM changes from the potential VHa to the reference potential Vref to expand the volume of the pressure chamber CV maintained by the waveform element Pa4 and attenuate the residual vibration of the ink in the pressure chamber CV. The volume of the pressure chamber CV maintained by the waveform element Pa4 corresponds to the volume of the pressure chamber CV contracted by the waveform element Pa3. As described above, the waveform element Pa5 is an element in which the potential of the drive signal COM changes from the potential VHa to the reference potential Vref, and expands the volume of the pressure chamber CV to attenuate the vibration of the ink in the pressure chamber CV. The waveform element Pa5 is an example of a "first vibration damping element".

As described above, the pulse PA is a so-called pull-push-pull waveform. However, the pulse PA is not limited to the pull-push-pull waveform. For example, the pulse PA may be a so-called pull-push waveform.

Next, a setting example of each element of the pulse PA will be described. The numerical values of the setting examples illustrated below are mainly calculated based on the experiments.

For example, as described in FIG. 4, the piezoelectric element PZ has a displacement characteristic in which the unit displacement amount decreases as the potential difference VAlh, which is the drive voltage v of the piezoelectric element PZ, increases. Therefore, for example, when a potential that changes from the potential VLa to the potential VHa is applied, the unit displacement amount of the piezoelectric element PZ is small as compared with the case where a potential that changes from the potential VLa to the center potential VCa between the potential VLa and the potential VHa is applied.

For example, it is preferable that the potential VLa and the potential VHa are set so that the first unit displacement amount when the potential applied to the piezoelectric element PZ changes from the potential VLa to the potential VHa is equal to or less than 75% of the second unit displacement amount when the potential applied to the piezoelectric element PZ changes from the potential VLa to the potential VCa. More preferably, the potential VLa and the potential VHa are set so that the first unit displacement amount is equal to or less than 50% of the second unit displacement amount.

Alternatively, it is preferable that the potential VLa and the potential VHa are set so that the first displacement amount of the piezoelectric element PZ per 1 V when a potential that changes from the potential VLa to the potential VHa is applied to the piezoelectric element PZ is equal to or less than 75% of the second displacement amount of the piezoelectric element PZ per 1 V when a potential that changes from the potential VLa to a potential higher than the potential VLa by 1 V is applied to the piezoelectric element PZ. More preferably, the potential VLa and the potential VHa are set so that the first displacement amount is equal to or less than 50% of the second displacement amount.

Alternatively, it is preferable that the potential VLa and the potential VHa are set so that a third displacement amount of the piezoelectric element PZ when a potential that changes by a predetermined amount of potential range is applied to the piezoelectric element PZ in a range including the potential VHa is equal to or less than 75% of a fourth displacement amount of the piezoelectric element PZ when a potential that changes by the predetermined amount of potential range is applied to the piezoelectric element PZ in a range including the potential VLa. More preferably, the potential VLa and the potential VHa are set so that the third displacement amount is equal to or less than 50% of the fourth displacement amount.

By setting the potential VLa and the potential VHa as in the example described above, the drive voltage v of the piezoelectric element PZ, which is the potential difference VAlh between the potential VLa and the potential VHa, can be used in a range in which the sensitivity of the change in the discharge characteristic of the ink with respect to the change in the drive voltage v is low. As a result, in the present embodiment, it is possible to suppress the change in the discharge characteristic of the ink when the drive voltage v supplied to the piezoelectric element PZ fluctuates.

As described with reference to FIG. 4, the pulse PA using the drive voltage v in a range in which the sensitivity of the change in the discharge amount of ink with respect to the change in the drive voltage v is low has a large discharge amount of ink as compared with the pulse PA using the drive voltage v in a range in which the sensitivity of the change in the discharge amount of ink with respect to the change in the drive voltage v is high. Therefore, when the drive voltage v of the piezoelectric element PZ is simply set in a range in which the sensitivity of the change in the discharge amount of ink with respect to the change in the drive voltage v is low, the discharge amount of ink may be larger than the desired discharge amount. The inventors of the present application confirmed by the experiment that it is possible to suppress the discharge amount of ink from being larger than the desired discharge amount by setting the absolute value of the change amount in potential per 1μs of the waveform element Pa3 for discharging ink to be equal to or less than 0.35 times the first potential difference, which is the absolute value of the potential difference VAlh between the potential VLa and the potential VHa. Therefore, the absolute value of the change amount in potential per 1μs of the waveform element Pa3 is preferably equal to or less than 0.35 times the first potential difference, which is the absolute value of the potential difference VAlh between the potential VLa and the potential VHa. In this case, it is possible to suppress the discharge amount of ink from being larger than the desired discharge amount. For example, even when the desired discharge amount is small, in the present embodiment, it is possible to discharge a desired discharge amount of ink while using the drive voltage v of the piezoelectric element PZ within a range that suppresses variations in the displacement amount of the piezoelectric element PZ when the drive voltage v fluctuates. Hereinafter, the first potential difference, which is the absolute value of the potential difference VAlh, is simply referred to as a potential difference VAlh.

In addition, the interval TIVa from the start of the waveform element Pa1 to the start of the waveform element Pa3 is preferably longer than 0.5 times the natural vibration cycle of the discharge section D and shorter than 0.75 times the natural vibration cycle. The natural vibration cycle of the discharge section D is, for example, a natural vibration cycle representing the natural vibration cycle of M discharge sections D. For example, the natural vibration cycle representing the natural vibration cycle of the M discharge sections D may be the natural vibration cycle of one discharge section D among the M discharge sections D. Alternatively, the natural vibration cycle representing the natural vibration cycle of the M discharge sections D may be an average value of the natural vibration cycles of the K discharge sections D, or may be a maximum value or a minimum value of the natural vibration cycles of the K discharge sections D. The value K is a natural number satisfying "2 ≤ K ≤ M". In the present embodiment, by setting the interval TIVa in a range longer than 0.5 times and shorter than 0.75 times the natural vibration cycle of the discharge section D, the waveform element Pa3 can be supplied to the piezoelectric element PZ at a timing when the peak of the natural vibration of the pressure fluctuation of the liquid in the pressure chamber CV generated by the waveform element Pa1 passed. As a result, it is possible to suppress the discharge amount of ink by intentionally supplying the waveform element Pa3 at a timing at which the discharge efficiency is not optimal, and it is possible to discharge a desired discharge amount of ink, with respect to the pressure fluctuation of the liquid in the pressure chamber CV generated by the waveform element Pa1.

In addition, the absolute value of the potential difference VAlr between the reference potential Vref and the potential VLa is preferably equal to or less than 0.55 times the potential difference VAlh, and the absolute value of the change amount in potential per 1μs of the waveform element Pa1 is preferably equal to or less than 0.25 times the potential difference VAlh. The lower limit of the absolute value of the change amount in potential per 1μs of the waveform element Pa1 is, for example, 0.15 times the potential difference VAlh. As described above, by reducing the potential change rate and the potential difference VAlr between the start point and the end point of the waveform element Pa1 which is the expansion element, it is possible to suppress the discharge amount of ink from being larger than the desired amount.

In addition, the period Ta from the start point to the end point of the waveform element Pa2 is preferably longer than 0.25 times the natural vibration cycle of the discharge section D and shorter than 0.43 times the natural vibration cycle. In this case, it is possible to suppress the discharge amount of ink from being larger than the desired amount.

An operation of the liquid discharge apparatus 1 is not limited to the example illustrated in FIG. 6. For example, a case where there is one drive signal COM for discharging an ink from the nozzle N is illustrated in FIG. 6, but the present disclosure is not limited to such an aspect. For example, the plurality of drive signals COM corresponding to sizes of dots may be used as the drive signals COM for discharging the ink from the nozzle N. Also in this case, each of the plurality of drive signals COM for discharging ink from the nozzle N is determined so that the drive voltage v of the piezoelectric element PZ is in a range in which the sensitivity of the change in the discharge amount of ink with respect to the change in the drive voltage v is low. A plurality of drive signals COM may be used which include one or both of the drive signals COM having a minute vibration waveform for preventing the thickening of the ink and the drive signal COM having a minute vibration waveform for generating residual vibration for evaluating the discharge state.

As described above, in the present embodiment, the liquid discharge apparatus 1 includes the head unit 3 having the plurality of discharge sections D each including the nozzle N that discharges ink, the pressure chamber CV that communicates with the nozzle N, and the piezoelectric element PZ that applies the pressure fluctuations to the ink in the pressure chamber CV according to the drive signal COM, and the drive signal generation unit 4 that generates the drive signal COM. The drive signal COM includes a pulse PA. The pulse PA includes a waveform element Pa3 that drives the piezoelectric element PZ so that the potential changes from the potential VLa to the potential VHa and the volume of the pressure chamber CV is contracted to discharge the ink from the nozzle N. The piezoelectric element PZ has a displacement characteristic in which, when a potential that changes from the potential VLa to the potential VHa is applied, a unit displacement amount, which is a displacement amount of the piezoelectric element PZ when a potential to be applied is changed by a unit amount, is small as compared with a case where a potential that changes from the potential VLa to the center potential VCa between the potential VLa and the potential VHa is applied. The absolute value of the change amount in potential per 1μs of the waveform element Pa3 is equal to or less than 0.35 times the first potential difference which is the absolute value of the potential difference between the potential VLa and the potential VHa.

As described above, in the present embodiment, the potential VLa of the start point and the potential VHa of the end point of the waveform element Pa3 that discharges ink from the nozzle N are determined so that the unit displacement amount of the piezoelectric element PZ is small as compared with the case where the piezoelectric element PZ is driven by the potential that changes from the potential VLa to the potential VCa. As a result, in the present embodiment, it is possible to suppress the change in the discharge characteristic of the ink when the potential applied to the piezoelectric element PZ is changed in order to discharge the ink from the nozzle N. In the present embodiment, since the absolute value of the change amount in potential per 1μs of the waveform element Pa3 is equal to or less than 0.35 times the first potential difference, it is possible to suppress the discharge amount of ink from being larger than the desired discharge amount. That is, in the present embodiment, it is possible to discharge a desired discharge amount of ink by using the drive voltage v determined by the potential VLa of the start point and the potential VHa of the end point of the waveform element Pa3 in a range in which the unit displacement amount of the piezoelectric element PZ is small.

In addition, in the present embodiment, the pulse PA may further include the waveform element Pa1, which is an element before the waveform element Pa3, a potential of which changes from the reference potential Vref to the potential VLa, and drives the piezoelectric element PZ to expand the volume of the pressure chamber CV, and the interval TIVa from the start of the waveform element Pa1 to the start of the waveform element Pa3 may be longer than 0.5 times and shorter than 0.75 times the natural vibration cycle of the discharge section D. In this case, it is possible to supply the waveform element Pa3 to the piezoelectric element PZ at a timing when the peak of the natural vibration cycle of the pressure fluctuation of the liquid in the pressure chamber CV generated by the waveform element Pa1 passed, it is possible to suppress the discharge amount of ink by supplying the waveform element Pa3 at the timing at which the discharge efficiency is not optimal, and it is possible to discharge a desired discharge amount of ink.

In the present embodiment, the absolute value of the potential difference VAlr between the reference potential Vref and the potential VLa may be equal to or less than 0.55 times the first potential difference, and the absolute value of the change amount in potential of the waveform element Pa1 per 1μs may be equal to or less than 0.25 times the first potential difference. In this case, since the potential difference VAlr between the reference potential Vref of the start point and the potential VLa of the end point of the waveform element Pa1, which is an expansion element, and the change amount in potential per 1μs of the waveform element Pa1 are reduced, it is possible to suppress the discharge amount of ink from being larger than the desired amount.

In the present embodiment, the pulse PA may further include the waveform element Pa2 in which the potential is maintained at the potential VLa from the end point of the waveform element Pa1 to the start point of the waveform element Pa3, and the period Ta from the start point to the end point of the waveform element Pa2 may be longer than 0.25 times and shorter than 0.43 times the natural vibration cycle of the discharge section D. In this case, it is possible to suppress the discharge amount of ink from being larger than the desired amount.

In the present embodiment, the potential difference VAlh from the potential VLa to the potential VHa is set so that the variation in the discharge amount of ink when the potential difference VAlh varies is within a predetermined allowable amount, and the change amount in potential per unit time of the waveform element Pa3 is set so that the discharge amount of ink is a desired amount. As a result, in the present embodiment, it is possible to suppress the change in the discharge characteristic of the ink when the potential applied to the piezoelectric element PZ is changed in order to discharge the ink from the nozzle N.

### Modification Example

Each embodiment above can be variously modified. Specific modification aspects are illustrated below. Two or more aspects selected in any manner from the following examples can be combined with each other as appropriate within a range not inconsistent with each other. In addition, in the modification examples described below, elements having the same effects and functions as those of the embodiment will be given the reference numerals used in the description above, and each detailed description thereof will be omitted as appropriate.

### First Modification Example

In the above-described embodiment, a case where the drive signal COM includes one pulse PA for discharging ink from the nozzle N is described as an example, but the present disclosure is not limited to such an aspect. For example, the drive signal COM may have a plurality of pulses for discharging ink from the nozzle N.

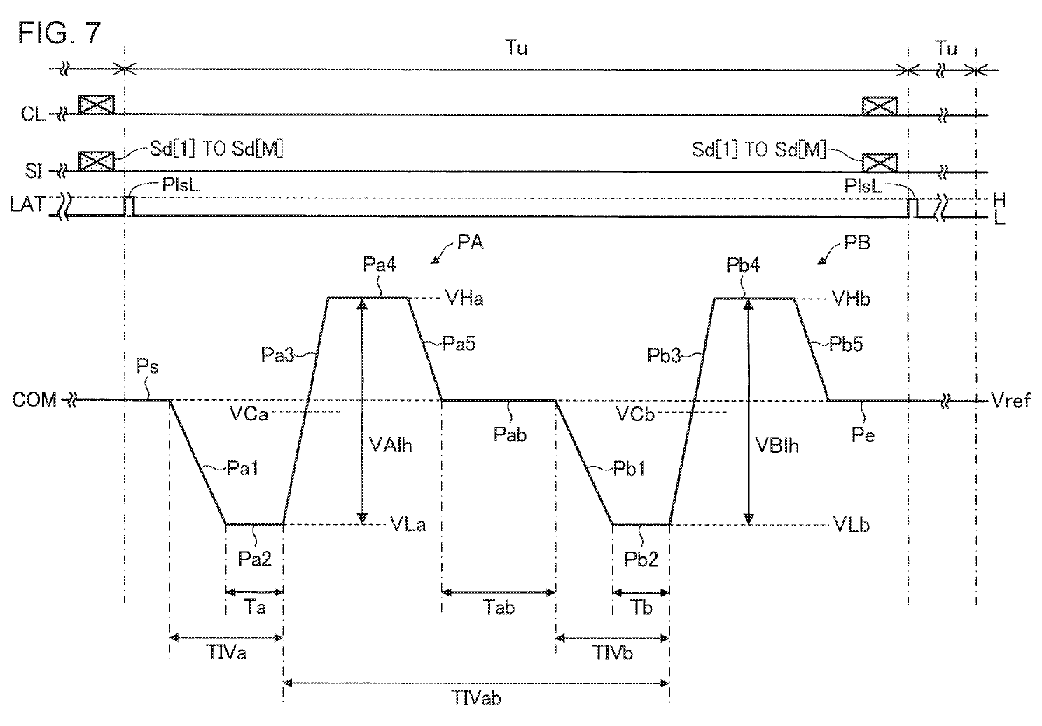

FIG. 7 is a timing chart illustrating an example of the operation of the liquid discharge apparatus 1 according to a first modification example. The timing chart illustrated in FIG. 7 is the same as the timing chart illustrated in FIG. 6 except that the drive signal COM includes a pulse PB after the pulse PA. In FIG. 7, the description will be made with reference to the pulse PB.

The drive signal COM includes a pulse PA and a pulse PB for discharging ink from the nozzle N, a waveform element Ps which is an element before the pulse PA, a waveform element Pe which is an element after the pulse PB, and a waveform element Pab which couples the pulse PA and the pulse PB. The pulse PB is an example of a "second discharge pulse", and the waveform element Pab is an example of a "pulse coupling element". The waveform element Ps, the pulse PA, the waveform element Pab, the pulse PB, and the waveform element Pe are supplied to the wiring La in the unit period Tu when, for example, the drive signal COM is supplied to the wiring La.

For example, the waveform element Ps is the same as the waveform element Ps illustrated in FIG. 6. In addition, the waveform element Pe is an element that maintains the potential of the drive signal COM at the reference potential Vref from the end of the pulse PB until the end of the unit period Tu. In addition, the waveform element Pab maintains the potential at the reference potential Vref from the end point of the waveform element Pa5 of the pulse PA to the start point of the waveform element Pb1 of the pulse PB, which will be described later. In the present modification example, the reference potential Vref is an example of a "third potential" and a "fourth potential".

The pulse PB is a pulse after the pulse PA, and has a pull-push-pull waveform similar to the pulse PA. For example, the pulse PB includes waveform elements Pb1, Pb2, Pb3, Pb4, and Pb5 corresponding to the waveform elements Pa1, Pa2, Pa3, Pa4, and Pa5 of the pulse PA, respectively. The same elements as those of the pulse PA will be omitted from the detailed description.

The pulse PB is a pulse in which the potential of the drive signal COM returns from the reference potential Vref to the reference potential Vref via the potential VLb and the potential VHb. The potential VLb is a potential lower than the reference potential Vref and is the lowest potential of the pulse PB. The potential VHb is a potential higher than the reference potential Vref and is the maximum potential of the pulse PB. That is, the reference potential Vref is a potential between the potential VLb and the potential VHb. The potential VLb is an example of a "fifth potential", and the potential VHb is an example of a "sixth potential". Similarly to the potential VLa and the potential VHa, the potential VLb and the potential VHb are also determined based on the ink discharge characteristic of the discharge section D and the like. For example, as described with reference to FIG. 4, the potential VLb and the potential VHb are determined so that the potential difference VBlh between the potential VLb and the potential VHb is in a range in which the sensitivity of the change in the discharge amount of ink with respect to the change in the potential difference VBlh is low. The potential change rate of the waveform element Pb3 included in the pulse PB is determined so that the discharge amount of ink is a desired discharge amount.

The waveform element Pb1 is an expansion element after the waveform element Pab. For example, in the waveform element Pb1, the potential of the drive signal COM changes from the reference potential Vref to the potential VLb to drive the piezoelectric element PZ to expand the volume of the pressure chamber CV. The waveform element Pb1 is an example of a "second expansion element".

The waveform element Pb2 is a maintenance element after the waveform element Pb1. For example, in the waveform element Pb2, the potential of the drive signal COM is maintained to drive the piezoelectric element PZ to maintain the volume of the pressure chamber CV expanded by the waveform element Pb1. Therefore, in the waveform element Pb2, the potential of the drive signal COM is maintained at the potential VLb which is the potential of the end point of the waveform element Pb1. For example, the waveform element Pb2 maintains the potential of the drive signal COM at the potential VLb from the end point of the waveform element Pb1 until the start point of the waveform element Pb3. The waveform element Pb2 is an example of a "second expansion maintenance element".

The waveform element Pb3 is a contraction element after the waveform element Pb2. For example, in the waveform element Pb3, the potential of the drive signal COM changes from the potential VLb to the potential VHb to drive the piezoelectric element PZ to contract the volume of the pressure chamber CV. As a result, the ink is discharged from the nozzle N. As described above, the waveform element Pb3 is an element in which the potential of the drive signal COM changes from the potential VLb to the potential VHb, and drives the piezoelectric element PZ to contract the volume of the pressure chamber CV and discharge the ink from the nozzle N. The waveform element Pb3 is an example of a "second discharge element".

The waveform element Pb4 is a maintenance element after the waveform element Pb3. For example, in the waveform element Pb4, the potential of the drive signal COM is maintained at the potential VHb of the end point of the waveform element Pb3 to drive the piezoelectric element PZ to maintain the volume of the pressure chamber CV contracted by the waveform element Pb3. For example, the waveform element Pb4 maintains the potential of the drive signal COM at the potential VHb from the end point of the waveform element Pb3 to the start point of the waveform element Pb5.

The waveform element Pb5 is an expansion element after the waveform element Pb4. For example, in the waveform element Pb5, the potential of the drive signal COM changes from the potential VHb to the reference potential Vref to expand the volume of the pressure chamber CV maintained by the waveform element Pb4 and attenuate the residual vibration of the ink in the pressure chamber CV. The volume of the pressure chamber CV maintained by the waveform element Pb4 corresponds to the volume of the pressure chamber CV contracted by the waveform element Pb3. As described above, the waveform element Pb5 is an element in which the potential of the drive signal COM changes from the potential VHb to the reference potential Vref, and expands the volume of the pressure chamber CV to attenuate the vibration of the ink in the pressure chamber CV.

Next, a setting example of each element of the pulse PB will be described.

Also in the present modification example, similarly to the potential VLa and the potential VHa, the potential VLb and the potential VHb are determined to be in a range in which the sensitivity of the displacement amount in the piezoelectric element PZ with respect to the change in the drive voltage v of the piezoelectric element PZ is low. For example, when a potential that changes from the potential VLb to the potential VHb is applied, the unit displacement amount of the piezoelectric element PZ is small as compared with a case where a potential that changes from the potential VLb to the center potential VCb between the potential VLb and the potential VHb is applied.

For example, it is preferable that the potential VLb and the potential VHb are set so that the third unit displacement amount when the potential applied to the piezoelectric element PZ changes from the potential VLb to the potential VHb is set to be equal to or less than 75% of the fourth unit displacement amount when the potential applied to the piezoelectric element PZ changes from the potential VLb to the potential VCb. More preferably, the potential VLb and the potential VHb are set so that the third unit displacement amount is equal to or less than 50% of the fourth unit displacement amount.

Alternatively, it is preferable that the potential VLb and the potential VHb be set so that the fifth displacement amount of the piezoelectric element PZ per 1 V when a potential that changes from the potential VLb to the potential VHb is applied to the piezoelectric element PZ is equal to or less than 75% of the sixth displacement amount of the piezoelectric element PZ per 1 V when a potential that changes from the potential VLb to a potential higher than the potential VLb by 1 V is applied to the piezoelectric element PZ. More preferably, the potential VLb and the potential VHb are set so that the fifth displacement amount is equal to or less than 50% of the sixth displacement amount.

Alternatively, it is preferable that the potential VLb and the potential VHb are set so that the seventh displacement amount of the piezoelectric element PZ when a potential that changes by a predetermined potential range including the potential VHb is applied to the piezoelectric element PZ is set to be equal to or less than 75% of the eighth displacement amount of the piezoelectric element PZ when a potential that changes by the predetermined potential range including the potential VLb is applied to the piezoelectric element PZ. More preferably, the potential VLb and the potential VHb are set so that the seventh displacement amount is equal to or less than 50% of the eighth displacement amount.

By setting the potential VLb and the potential VHb as in the example described above, the drive voltage v of the piezoelectric element PZ, which is the potential difference VBlh between the potential VLb and the potential VHb, can be used in a range in which the sensitivity of the change in the discharge characteristic of ink with respect to the change in the drive voltage v is low. As a result, in the present embodiment, it is possible to suppress the change in the discharge characteristic of the ink when the drive voltage v supplied to the piezoelectric element PZ fluctuates.

In addition, similarly to the waveform element Pa3 of the pulse PA, the absolute value of the change amount in potential per 1μs of the waveform element Pb3 is preferably equal to or less than 0.35 times the second potential difference which is the absolute value of the potential difference VBlh between the potential VLb and the potential VHb. In this case, it is possible to suppress the discharge amount of ink from being larger than the desired discharge amount. For example, even when the desired discharge amount is small, in the present modification example, the desired discharge amount of ink can be discharged while using the drive voltage v of the piezoelectric element PZ in a range in which the variation in the displacement amount of the piezoelectric element PZ when the drive voltage v fluctuates is suppressed. Hereinafter, the second potential difference, which is the absolute value of the potential difference VBlh, is simply referred to as the potential difference VBlh.

In addition, the interval TIVb from the start of the waveform element Pb1 to the start of the waveform element Pb3 is, for example, longer than 0.5 times and shorter than 0.75 times the natural vibration cycle of the discharge section D. As a result, it is possible to supply the waveform element Pb3 to the piezoelectric element PZ at a timing when the peak of the natural vibration of the pressure fluctuation of the liquid in the pressure chamber CV generated by the waveform element Pb1 passed. As a result, it is possible to suppress the discharge amount of ink by intentionally supplying the waveform element Pb3 at a timing at which the discharge efficiency is not optimal, and it is possible to discharge a desired discharge amount of ink, with respect to the pressure fluctuation of the liquid in the pressure chamber CV generated by the waveform element Pb1.

In addition, the absolute value of the change amount in potential per 1μs of the waveform element Pb1 is, for example, equal to or less than 0.25 times the potential difference VBlh. The lower limit of the absolute value of the change amount in potential per 1μs of the waveform element Pb1 is, for example, 0.15 times the potential difference VBlh. As described above, by reducing the potential change rate of the waveform element Pb1 which is the expansion element, it is possible to suppress the discharge amount of ink from being larger than the desired amount. The absolute value of the potential difference VBlr between the reference potential Vref and the potential VLb may be equal to or less than 0.55 times the potential difference VBlh.

In addition, the period Tb from the start point to the end point of the waveform element Pb2 may be longer than 0.25 times and shorter than 0.43 times the natural vibration cycle of the discharge section D. In this case, it is possible to suppress the discharge amount of ink from being larger than the desired amount.

In addition, the interval TIVab from the start of the waveform element Pa3 to the start of the waveform element Pb3 is preferably equal to or greater than 4.15 times the natural vibration cycle of the discharge section D. The upper limit of the interval TIVab is, for example, six times the natural vibration cycle of the discharge section D. When the interval TIVab is equal to or greater than 4.15 times the natural vibration cycle of the discharge section D, it is possible to suppress the discharge characteristic of the ink discharged by the waveform element Pb3 from being affected by the residual vibration due to the waveform element Pa3.

In addition, the period Tab from the start point to the end point of the waveform element Pab is preferably equal to or greater than 2 times the natural vibration cycle of the discharge section D. The upper limit of the period Tab is, for example, four times the natural vibration cycle of the discharge section D. When the period Tab is equal to or greater than 2 times the natural vibration cycle of the discharge section D, it is possible to suppress the discharge characteristic of the ink discharged by the pulse PB from being affected by the residual vibration due to the pulse PA. For example, it is possible to suppress the discharge amount of ink discharged by the pulse PB from being larger than the desired discharge amount due to the influence of the residual vibration due to the pulse PA.

As described above, in the present modification example, the pulse PA and the pulse PB are determined so that the drive voltagev of the piezoelectric element PZ is in a range in which the sensitivity of the change in the ink discharge characteristic with respect to the change in the drive voltage v is low. As a result, in the present modification example, the discharge amount of ink in one unit period Tu can be made to be a desired discharge amount while suppressing the variation in the discharge amount of ink when the drive voltage v varies.

The operation of the liquid discharge apparatus 1 in the present modification example is not limited to the example illustrated in FIG. 7. For example, the pulse PB is not limited to the pull-push-pull waveform. Specifically, for example, the pulse PB may be a pull-push waveform. In addition, for example, the drive signal COM may have pulses that are equal to or greater than 3 for discharging ink from the nozzle N. In addition, for example, a plurality of pulses including the pulse PA and the pulse PB may be pulses for discharging ink for forming dots having different sizes from each other from the nozzle N. For example, the potential of the end point of the waveform element Pa5 of the pulse PA and the potential of the start point of the waveform element Pb1 of the pulse PB may be a potential which is different from the reference potential Vref.

In addition, for example, the potential VLb may be the same potential as the potential VLa, or may be a potential different from the potential VLa. Similarly, the potential VHb may be the same potential as the potential VHa or may be a potential different from the potential VHa. In addition, the first potential difference, which is the absolute value of the potential difference VAlh between the potential VLa and the potential VHa, may be the same as or different from the second potential difference, which is the absolute value of the potential difference VBlh between the potential VLb and the potential VHb. However, the first potential difference is preferably smaller than the second potential difference. When the first potential difference is smaller than the second potential difference, the residual vibration generated due to the pulse PA can be suppressed as compared with a case where the first potential difference is equal to or greater than the second potential difference. As a result, it is possible to suppress the discharge amount of ink discharged by the pulse PB from being larger than the desired discharge amount.

As described above, in the present modification example, the drive signal COM further includes the pulse PB after the pulse PA. The pulse PB includes the waveform element Pb1 in which the potential changes from the reference potential Vref to the potential VLb and which drives the piezoelectric element PZ so that the volume of the pressure chamber CV expands, the waveform element Pb3 in which the potential changes from the potential VLb to the potential VHb and which drives the piezoelectric element PZ so that the volume of the pressure chamber CV is contracted to discharge the ink from the nozzle N, and the waveform element Pb2 which maintains the potential at the potential VLb from the end point of the waveform element Pb1 to the start point of the waveform element Pb3. When a potential that changes from the potential VLb to the potential VHb is applied, the unit displacement amount of the piezoelectric element PZ is small as compared with the case where a potential that changes from the potential VLb to the center potential VCb between the potential VLb and the potential VHb is applied. The absolute value of the change amount in potential per 1μs of the waveform element Pb1 is equal to or less than 0.25 times a second potential difference, which is the absolute value of the potential difference VBlh between the potential VLb and the potential VHb. The interval TIVb from the start of the waveform element Pb1 to the start of the waveform element Pb3 is longer than 0.5 times and shorter than 0.75 times the natural vibration cycle of the discharge section D. The absolute value of the change amount in potential per 1μs of the waveform element Pb3 is equal to or less than 0.35 times the second potential difference.

As described above, in the present modification example, the drive signal COM further includes the pulse PB after the pulse PA. In addition, similarly to the waveform element Pa3 of the pulse PA, the waveform element Pb3 of the pulse PB is determined so that the drive voltage v determined by the potential VLb of the start point and the potential VHb of the end point of the waveform element Pb3 is in the range in which the unit displacement amount of the piezoelectric element PZ is small. As a result, in the present modification example, it is possible to set the discharge amount of ink in the one-unit period Tu, which is one drive cycle of the discharge section D, to the desired discharge amount while suppressing the variation in the discharge amount of ink when the drive voltage v of the discharge section D varies.

In addition, in the present modification example, the interval TIVab from the start of the waveform element Pa3 to the start of the waveform element Pb3 may be equal to or greater than 4.15 times the natural vibration cycle of the discharge section D. It is possible to suppress the discharge characteristic of the ink discharged by the waveform element Pb3 from being affected by the residual vibration due to the waveform element Pa3.

In addition, in the present modification example, the period Tab from the start point to the end point of the waveform element Pab may be equal to or longer than twice the natural vibration cycle of the discharge section D. In this case, it is possible to suppress the discharge characteristic of the ink discharged by the pulse PB from being affected by the residual vibration due to the pulse PA.

In addition, in the present modification example, the first potential difference may be smaller than the second potential difference. In this case, the residual vibration generated due to the pulse PA can be suppressed as compared with the case where the first potential difference is equal to or greater than the second potential difference. As a result, it is possible to suppress the discharge amount of ink discharged by the pulse PB from being larger than the desired discharge amount.

### Second Modification Example

In the above-described embodiment, a case where the liquid discharge apparatus 1 has four head units 3 is exemplified, but the present disclosure is not limited to such an aspect. For example, the liquid discharge apparatus 1 may have the head units 3 the number of which is equal to or greater than 1 and equal to or less than 3, or may have the head units 3 the number of which is equal to or greater than 5. Also in the present modification example, the same effect as in the embodiment described above can be obtained.

### Third Modification Example

In the above-described embodiment and modification example, a case where the liquid discharge apparatus 1 is a serial printer is exemplified, but the present disclosure is not limited to such an aspect. For example, the liquid discharge apparatus 1 may be a so-called line printer in which the plurality of nozzles N are provided in the head unit 3 to extend wider than the width of the recording paper sheet PP. In the present modification example as well, the same effect as in the embodiment and modification examples described above can be obtained.

### Fourth Modification Example

In the embodiment and modification example described above, a case is described as an example in which the piezoelectric element PZ is displaced in the Z2 direction by changing a potential of the individual drive signal Vin[m] from a low potential to a high potential, and the present disclosure is not limited to such an aspect. For example, the piezoelectric element PZ that is displaced in the Z2 direction by the potential of the individual drive signal Vin[m] changing from the high potential to the low potential may be used. In this case, for example, the potential of the drive signal COM is changed from the low potential to the high potential in a section corresponding to an expansion element and is changed from the high potential to the low potential in a section corresponding to a contraction element. Also in the present modification example, the drive voltage v of the piezoelectric element PZ is determined so that the drive voltage v is in a range in which the unit displacement amount of the piezoelectric element PZ is small. Therefore, also in the present modification example, the same effects as in the above-described embodiment and modification example can be obtained.

### Appendices

From the embodiments described above, for example, the following configuration can be ascertained.

According to a first aspect, which is a preferred aspect, there is provided a liquid discharge apparatus including: a liquid discharge head that includes a plurality of discharge sections each of which includes a nozzle that discharges a liquid, a pressure chamber that communicates with the nozzle, and a piezoelectric element that applies a pressure fluctuation to a liquid in the pressure chamber according to a drive signal; and a drive signal generation section that generates the drive signal, in which the drive signal includes a first discharge pulse, the first discharge pulse includes a first discharge element that drives the piezoelectric element so that a potential changes from a first potential to a second potential and a volume of the pressure chamber is contracted to discharge the liquid from the nozzle, the piezoelectric element has a displacement characteristic in which, when a potential that changes from the first potential to the second potential is applied, a unit displacement amount, which is a displacement amount of the piezoelectric element when the applied potential changes by a unit amount, is smaller than when a potential that changes from the first potential to a center potential between the first potential and the second potential is applied, and an absolute value of a change amount of a potential per 1μs of the first discharge element is equal to or less than 0.35 times a first potential difference which is an absolute value of a potential difference between the first potential and the second potential.

According to the first aspect, it is possible to discharge the desired discharge amount of ink while using the drive voltage determined by the first potential of the start point of the first discharge pulse and the second potential of the end point of the first discharge pulse in a range in which the unit displacement amount of the piezoelectric element is small.

In a liquid discharge apparatus according to a second aspect which is a specific example of the first aspect, the first discharge pulse further includes a first expansion element that is an element before the first discharge element and drives the piezoelectric element so that the potential changes from a third potential to the first potential to expand the volume of the pressure chamber, and an interval from a start of the first expansion element to a start of the first discharge element is longer than 0.5 times and shorter than 0.75 times a natural vibration cycle of the discharge section.

According to the second aspect, the residual vibration due to the drive signal can be suppressed.

In a liquid discharge apparatus according to a third aspect, which is a specific example of the first or second aspect, an absolute value of a potential difference between the third potential and the first potential is equal to or less than 0.55 times the first potential difference, and an absolute value of a change amount of a potential per 1μs of the first expansion element is equal to or less than 0.25 times the first potential difference.

According to the third aspect, it is possible to suppress the discharge amount of liquid from being larger than the desired amount.

In a liquid discharge apparatus according to a fourth aspect, which is a specific example of the first to third aspects, the first discharge pulse further includes a first expansion maintenance element that maintains a potential at the first potential from an end point of the first expansion element to a start point of the first discharge element, and a period from a start point to an end point of the first expansion maintenance element is longer than 0.25 times and shorter than 0.43 times the natural vibration cycle of the discharge section.

According to the fourth aspect, it is possible to ensure the stability of the discharge of the liquid.

In a liquid discharge apparatus according to a fifth aspect, which is a specific example of any one of the first to fourth aspects, the drive signal further includes a second discharge pulse after the first discharge pulse, the second discharge pulse includes a second expansion element that drives the piezoelectric element so that the potential changes from a fourth potential to a fifth potential to expand the volume of the pressure chamber, a second discharge element that drives the piezoelectric element so that the potential changes from a fifth potential to a sixth potential to contract the volume of the pressure chamber and discharge the liquid from the nozzle, and a second expansion maintenance element that maintains the potential at the fifth potential from an end point of the second expansion element to a start point of the second discharge element, when the potential that changes from the fifth potential to the sixth potential is applied, the unit displacement amount of the piezoelectric element is smaller than when a potential that changes from the fifth potential to a center potential between the fifth potential and the sixth potential is applied, an absolute value of a change amount of a potential per 1μs of the second expansion element is equal to or less than 0.25 times a second potential difference which is an absolute value of a potential difference between the fifth potential and the sixth potential, an interval from a start of the second expansion element to a start of the second discharge element is longer than 0.5 times and shorter than 0.75 times a natural vibration cycle of the discharge section, and an absolute value of a change amount of a potential per 1μs of the second discharge element is equal to or less than 0.35 times the second potential difference.

According to the fifth aspect, the discharge amount of liquid during one drive cycle of the discharge section can be increased while suppressing the variation in the discharge amount of liquid when the drive voltage of the discharge section varies.

In a liquid discharge apparatus according to a sixth aspect, which is a specific example of the fifth aspect, an interval from the start of the first discharge element to the start of the second discharge element is equal to or greater than 4.15 times the natural vibration cycle of the discharge section.

According to the sixth aspect, it is possible to suppress the discharge characteristic of the liquid discharged by the second discharge element from being affected by the residual vibration due to the first discharge element.

In a liquid discharge apparatus according to a seventh aspect, which is a specific example of the fifth or sixth aspect, the first discharge pulse further includes a first contraction maintenance element that maintains a potential at the second potential from an end point of the first discharge element, and a first vibration damping element that is an element after the first contraction maintenance element, in which the potential changes from the second potential to the fourth potential, and that expands the volume of the pressure chamber to attenuate vibration of the liquid in the pressure chamber, the drive signal further includes a pulse coupling element that maintains a potential at the fourth potential from an end point of the first vibration damping element to a start point of the second expansion element, and a period from a start point to an end point of the pulse coupling element is equal to or greater than 2 times the natural vibration cycle of the discharge section.

According to the seventh aspect, it is possible to suppress the discharge characteristic of the liquid discharged by the second discharge pulse from being affected by the residual vibration due to the first discharge pulse.

In a liquid discharge apparatus according to an eighth aspect, which is a specific example of any one of the fifth to seventh aspects, the first potential difference is less than the second potential difference.

According to the eighth aspect, it is possible to suppress the discharge amount of liquid discharged by the second discharge pulse from being larger than the desired discharge amount.

In addition, according to a ninth aspect, which is another preferred aspect, there is provided a liquid discharge apparatus including: a liquid discharge head that includes a plurality of discharge sections each of which includes a nozzle that discharges a liquid, a pressure chamber that communicates with the nozzle, and a piezoelectric element that applies a pressure fluctuation to a liquid in the pressure chamber according to a drive signal; and a drive signal generation section that generates the drive signal, in which the drive signal includes a first discharge pulse, the first discharge pulse includes a first discharge element that drives the piezoelectric element so that a potential changes from a first potential to a second potential and a volume of the pressure chamber is contracted to discharge the liquid from the nozzle, a potential difference from the first potential to the second potential is set so that a variation in a discharge amount of the liquid when the potential difference varies is within a predetermined allowable amount, and a change amount of a potential per unit time of the first discharge element is set so that the discharge amount of liquid is a desired amount.

According to the ninth aspect, it is possible to suppress the change in the discharge amount of liquid when the potential applied to the piezoelectric element for discharging the liquid from the nozzle is changed.

In addition, according to a tenth aspect, which is a preferred aspect, there is provided a control method of a liquid discharge apparatus including a liquid discharge head that includes a plurality of discharge sections each of which includes a nozzle that discharges a liquid, a pressure chamber that communicates with the nozzle, and a piezoelectric element that applies a pressure fluctuation to a liquid in the pressure chamber according to a drive signal, and a drive signal generation section that generates the drive signal, in which the drive signal includes a first discharge pulse, the first discharge pulse includes a first discharge element that drives the piezoelectric element so that a potential changes from a first potential to a second potential and a volume of the pressure chamber is contracted to discharge the liquid from the nozzle, when a potential that changes from the first potential to the second potential is applied, a unit displacement amount, which is a displacement amount of the piezoelectric element when the applied potential changes by a unit amount, is smaller than when a potential that changes from the first potential to a center potential between the first potential and the second potential is applied, and an absolute value of a change amount of a potential per 1μs of the first discharge element is equal to or less than 0.35 times a first potential difference which is an absolute value of a potential difference between the first potential and the second potential.

According to the tenth aspect, the same effect as in the first aspect can be obtained.

In a control method of a liquid discharge apparatus according to an eleventh aspect, which is a specific example of the tenth aspect, the first discharge pulse further includes a first expansion element that is an element before the first discharge element and drives the piezoelectric element so that the potential changes from a third potential to the first potential to expand the volume of the pressure chamber, and an interval from a start of the first expansion element to a start of the first discharge element is longer than 0.5 times and shorter than 0.75 times a natural vibration cycle of the discharge section.

According to the eleventh aspect, the same effect as in the second aspect can be obtained.

In a control method of a liquid discharge apparatus according to a twelfth aspect, which is a specific example of the tenth or eleventh aspect, an absolute value of a potential difference between the third potential and the first potential is equal to or less than 0.55 times the first potential difference, and an absolute value of a change amount of a potential per 1μs of the first expansion element is equal to or less than 0.25 times the first potential difference.

According to the twelfth aspect, the same effect as in the third aspect can be obtained.

In a control method of a liquid discharge apparatus according to a thirteenth aspect, which is a specific example of the tenth to twelfth aspect, the first discharge pulse further includes a first expansion maintenance element that maintains a potential at the first potential from an end point of the first expansion element to a start point of the first discharge element, and a period from a start point to an end point of the first expansion maintenance element is longer than 0.25 times and shorter than 0.43 times the natural vibration cycle of the discharge section.

According to the thirteenth aspect, the same effect as in the fourth aspect can be obtained.

In a control method of a liquid discharge apparatus according to a fourteenth aspect, which is a specific example of any one of the tenth to thirteenth aspects, the drive signal further includes a second discharge pulse after the first discharge pulse, the second discharge pulse includes a second expansion element that drives the piezoelectric element so that the potential changes from a fourth potential to a fifth potential to expand the volume of the pressure chamber, a second discharge element that drives the piezoelectric element so that the potential changes from a fifth potential to a sixth potential to contract the volume of the pressure chamber and discharge the liquid from the nozzle, and a second expansion maintenance element that maintains the potential at the fifth potential from an end point of the second expansion element to a start point of the second discharge element, when the potential that changes from the fifth potential to the sixth potential is applied, the unit displacement amount of the piezoelectric element is smaller than when a potential that changes from the fifth potential to a center potential between the fifth potential and the sixth potential is applied, an absolute value of a change amount of a potential per 1μs of the second expansion element is equal to or less than 0.25 times a second potential difference which is an absolute value of a potential difference between the fifth potential and the sixth potential, an interval from a start of the second expansion element to a start of the second discharge element is longer than 0.5 times and shorter than 0.75 times a natural vibration cycle of the discharge section, and an absolute value of a change amount of a potential per 1μs of the second discharge element is equal to or less than 0.35 times the second potential difference.

According to the fourteenth aspect, the same effect as in the fifth aspect can be obtained.

In a control method of a liquid discharge apparatus according to a fifteenth aspect, which is a specific example of the fourteenth aspect, an interval from the start of the first discharge element to the start of the second discharge element is equal to or greater than 4.15 times the natural vibration cycle of the discharge section.

According to the fifteenth aspect, the same effect as in the sixth aspect can be obtained.

In a control method of a liquid discharge apparatus according to a sixteenth aspect, which is a specific example of the fourteenth or fifteenth aspect, the first discharge pulse further includes a first contraction maintenance element that maintains a potential at the second potential from an end point of the first discharge element, and a first vibration damping element that is an element after the first contraction maintenance element, in which the potential changes from the second potential to the fourth potential, and that expands the volume of the pressure chamber to attenuate vibration of the liquid in the pressure chamber, the drive signal further includes a pulse coupling element that maintains a potential at the fourth potential from an end point of the first vibration damping element to a start point of the second expansion element, and a period from a start point to an end point of the pulse coupling element is equal to or greater than 2 times the natural vibration cycle of the discharge section.

According to the sixteenth aspect, the same effect as in the seventh aspect can be obtained.

In a control method of the liquid discharge apparatus according to a seventeenth aspect, which is a specific example of any one of the fourteenth to sixteenth aspects, the first potential difference is less than the second potential difference.

According to the seventeenth aspect, the same effect as in the eighth aspect can be obtained.

In addition, according to an eighteenth aspect, which is another preferred aspect, a control method of a liquid discharge apparatus including a liquid discharge head that includes a plurality of discharge sections each of which includes a nozzle that discharges a liquid, a pressure chamber that communicates with the nozzle, and a piezoelectric element that applies a pressure fluctuation to a liquid in the pressure chamber according to a drive signal, and a drive signal generation section that generates the drive signal, in which the drive signal includes a first discharge pulse, the first discharge pulse includes a first discharge element that drives the piezoelectric element so that a potential changes from a first potential to a second potential and a volume of the pressure chamber is contracted to discharge the liquid from the nozzle, a potential difference from the first potential to the second potential is set so that a variation in a discharge amount of the liquid when the potential difference varies is within a predetermined allowable amount, and a change amount of a potential per unit time of the first discharge element is set so that the discharge amount of liquid is a desired amount.

According to the eighteenth aspect, the same effect as in the ninth aspect can be obtained.

What is claimed is:

1. A liquid discharge apparatus comprising:
a liquid discharge head that includes a plurality of discharge sections each of which includes a nozzle that discharges a liquid, a pressure chamber that communicates with the nozzle, and a piezoelectric element that is configured to apply a pressure fluctuation to a liquid in the pressure chamber according to a drive signal; and
a drive signal generation section that is configured to generate the drive signal, wherein
the drive signal includes a first discharge pulse,
the first discharge pulse includes a first discharge element that changes from a first potential to a second potential to drive the piezoelectric element so that a volume of the pressure chamber is contracted to discharge the liquid from the nozzle,
the piezoelectric element has a displacement characteristic in which, when a potential applied to the piezoelectric element changes from the first potential to the second potential, a unit displacement amount, which is a displacement amount of the piezoelectric element when the applied potential changes by a unit amount, is smaller than when a potential applied to the piezoelectric element changes from the first potential to a center potential between the first potential and the second potential, and
an absolute value of a change amount of a potential per 1μs of the first discharge element is equal to or less than 0.35 times a first potential difference which is an absolute value of a potential difference between the first potential and the second potential.

2. The liquid discharge apparatus according to claim 1, wherein
the first discharge pulse further includes a first expansion element that is an element before the first discharge element and changes the potential from a third potential to the first potential to drive the piezoelectric element so that the volume of the pressure chamber is expanded, and
an interval from a start of the first expansion element to a start of the first discharge element is longer than 0.5 times and shorter than 0.75 times a natural vibration cycle of the discharge section.

3. The liquid discharge apparatus according to claim 2, wherein
an absolute value of a potential difference between the third potential and the first potential is equal to or less than 0.55 times the first potential difference, and
an absolute value of a change amount of a potential per 1μs of the first expansion element is equal to or less than 0.25 times the first potential difference.

4. The liquid discharge apparatus according to claim 2, wherein
the first discharge pulse further includes a first expansion maintenance element that maintains a potential at the first potential from an end point of the first expansion element to a start point of the first discharge element, and
a period from a start point to an end point of the first expansion maintenance element is longer than 0.25 times and shorter than 0.43 times the natural vibration cycle of the discharge section.

5. The liquid discharge apparatus according to claim 1, wherein
the drive signal further includes a second discharge pulse after the first discharge pulse,
the second discharge pulse includes
a second expansion element that changes the potential from a fourth potential to a fifth potential to drive the piezoelectric element so that the volume of the pressure chamber is expanded,
a second discharge element that changes the potential from a fifth potential to a sixth potential to drive the piezoelectric element so that the volume of the pressure chamber is contracted to discharge the liquid from the nozzle, and
a second expansion maintenance element that maintains the potential at the fifth potential from an end point of the second expansion element to a start point of the second discharge element,
when the potential applied to the piezoelectric element changes from the fifth potential to the sixth potential, the unit displacement amount of the piezoelectric element is smaller than when a potential applied to the piezoelectric element changes from the fifth potential to a center potential between the fifth potential and the sixth potential,
an absolute value of a change amount of a potential per 1μs of the second expansion element is equal to or less than 0.25 times a second potential difference which is an absolute value of a potential difference between the fifth potential and the sixth potential,
an interval from a start of the second expansion element to a start of the second discharge element is longer than 0.5 times and shorter than 0.75 times a natural vibration cycle of the discharge section, and
an absolute value of a change amount of a potential per 1μs of the second discharge element is equal to or less than 0.35 times the second potential difference.

6. The liquid discharge apparatus according to claim 5, wherein
an interval from the start of the first discharge element to the start of the second discharge element is equal to or greater than 4.15 times the natural vibration cycle of the discharge section.

7. The liquid discharge apparatus according to claim 5, wherein
the first discharge pulse further includes
a first contraction maintenance element that maintains a potential at the second potential from an end point of the first discharge element, and
a first vibration damping element that is an element after the first contraction maintenance element, in which the potential changes from the second potential to the fourth potential so that the volume of the pressure chamber is expanded to attenuate vibration of the liquid in the pressure chamber,
the drive signal further includes a pulse coupling element that maintains a potential at the fourth potential from an end point of the first vibration damping element to a start point of the second expansion element, and
a period from a start point to an end point of the pulse coupling element is equal to or greater than 2 times the natural vibration cycle of the discharge section.

8. The liquid discharge apparatus according to claim 5, wherein
the first potential difference is less than the second potential difference.

9. A control method of a liquid discharge apparatus including a liquid discharge head that includes a plurality of discharge sections each of which includes a nozzle that discharges a liquid, a pressure chamber that communicates with the nozzle, and a piezoelectric element that is configured to apply a pressure fluctuation to a liquid in the pressure chamber according to a drive signal, and a drive signal generation section that is configured to generate the drive signal, wherein
the drive signal includes a first discharge pulse,
the first discharge pulse includes a first discharge element that changes a potential from a first potential to a second potential to drive the piezoelectric element so that a volume of the pressure chamber is contracted to discharge the liquid from the nozzle,
when a potential applied to the piezoelectric element changes from the first potential to the second potential, a unit displacement amount, which is a displacement amount of the piezoelectric element when the applied potential changes by a unit amount, is smaller than when a potential applied to the piezoelectric element changes from the first potential to a center potential between the first potential and the second potential, and
an absolute value of a change amount of a potential per 1μs of the first discharge element is equal to or less than 0.35 times a first potential difference which is an absolute value of a potential difference between the first potential and the second potential.

10. A control method of a liquid discharge apparatus including a liquid discharge head that includes a plurality of discharge sections each of which includes a nozzle that discharges a liquid, a pressure chamber that communicates with the nozzle, and a piezoelectric element that is configured to apply a pressure fluctuation to a liquid in the pressure chamber according to a drive signal, and a drive signal generation section that is configured to generate the drive signal, wherein
the drive signal includes a first discharge pulse,
the first discharge pulse includes a first discharge element that changes a potential from a first potential to a second potential to drive the piezoelectric element so that a volume of the pressure chamber is contracted to discharge the liquid from the nozzle,
a potential difference from the first potential to the second potential is set so that a variation in a discharge amount of the liquid when the potential difference varies is within a predetermined allowable amount, and
a change amount of a potential per unit time of the first discharge element is set so that the discharge amount of liquid is a desired amount.
